(19) United States
(12) Patent Application Publication
(10) Pub. No.: US 2013/0046619 A1
(43) Pub. Date: Feb. 21, 2013

(54) SYSTEM AND METHOD FOR TARGETED ADVERTISING

(71) Applicants: Daniel Alberto TRANSLATEUR, Raanana (IL); Michael Moshe DOLEV, Oranit (IL)

(72) Inventors: Daniel Alberto TRANSLATEUR, Raanana (IL); Michael Moshe DOLEV, Oranit (IL)

(21) Appl. No.: 13/568,475

(22) Filed: Aug. 7, 2012

Related U.S. Application Data
(60) Provisional application No. 61/523,409, filed on Aug. 15, 2011.

(51) Int. Cl. G06Q 30/02

(52) U.S. Cl. 705/14.46; 705/14.49; 705/14.58

(57) ABSTRACT

The invention improves the targeting accuracy and hence efficiency of retail advertising, by use of interactive, behavioral, and contextual advertising). Improvement in the relevance of an ad to the recipient thereof is central to the system, where relevance here is taken to involve many factors including relevance of item to customer, relevance of customer to advertiser, timing of advert, context of advert, context of customer, advertising return on investment (ROI), and advertisement usefulness to customer.

### BACKGROUND

1.Technical Field

Embodiments of the present invention relate generally to systems and methods for targeted advertising to shoppers.

2. Description of Related Art

Targeted advertising systems that pinpoint customers based on demographic and the like abound, for instance TV advertisements for certain market segments appearing at times during which a given segment will be more likely to tune in. However systems based on detailed, precise criteria on both the part of consumer and advertiser are lacking.

Hence, an improved method for targeted advertising is still a long felt need.

### BRIEF SUMMARY

According to an aspect of the present invention, there is provided a system and method for a shopping list which has targeted ads appearing by each item in the list.

It is within provision of the invention to implement a method for targeted advertising comprising steps of:
a. composing a shopping list;
b. compiling advertising information;
c. compiling user information;
d. determining the relevance of a given advertisement to a given user;
e. presenting advertisements to selected users depending upon said relevance.

It is further within provision of the invention wherein said advertising information comprises: keyword; distance between user domicile and a given outlet; distance from historic user purchase locations, distance of location when activating application, minimum distance between user commute route and a given outlet; distance between user work location and a given outlet.

It is further within provision of the invention wherein said distances are selected from the group consisting of: Euclidean distance; travel time; and functions thereof.

It is further within provision of the invention wherein said user information comprises: user age; user gender; user domicile location; user income; user family status; user work location; user commute route.

It is further within provision of the invention wherein said relevance is determined by means of a set of filters based on said advertising information, said user information, relevance of item to customer, relevance of customer to advertiser, timing of advert, context of advert, context of customer, advertising return on investment (ROI), and advertisement usefulness to customer.

It is further within provision of the invention wherein said relevance R is computed by means of the product

$$R = {\prod }_{k = 1}^{N} {r}_{k}$$

Where the rₖ are individual scores of relevance on individual indices. It is further within provision of the invention wherein said advertisement is presented to said user if said relevance R is greater than a predetermined threshold.

It is further within provision of the invention further comprising means for storing historical shopping list information.

It is further within provision of the invention further comprising means for prediction of shopping needs based on said historical information.

It is further within provision of the invention wherein said shopping list is composed by means selected from the group consisting of: manual input; automated prediction; and combinations thereof.

It is further within provision of the invention implemented on a mobile device.

It is further within provision of the invention wherein said advertising information and said user information are stored on means selected from the group consisting of: a server associated with said method; a mobile device associated with said user; and combinations thereof.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 displays advertiser defined keywords;

FIG. 2 illustrates advertiser defined ads attached to keywords;

FIG. 3 depicts ad icons appearing in the shopping list of a relevant shopper.

FIG. 4 depicts an ad appearing in the shopping list of a relevant shopper.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for targeted advertising.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

the term ‘mobile device’ refers hereinafter to any portable electronic device having networked, wi/fi, or any other form of connectivity or data transfer including smartphones, PDAs, laptop computers, gen3 phones, tablets, and the like.

Interactive advertising uses interactive media to communicate with consumers in order to promote products, brands, services, and public service announcements, corporate or political groups.

Behavioral targeting uses information collected on an individual's online web-browsing behavior, such as the pages they have visited or the searches they have made, to select which advertisements to display to that individual. Behavioral targeting also uses offline user behavior, such as a record of a user's visiting certain physical locations, to select which advertisements to display to that individual.

Contextual advertising is a form of targeted advertising for advertisements appearing on websites or other media, such as content displayed in mobile browsers and applications on mobile devices. The advertisements themselves are selected and served by automated systems based (for instance) on the content displayed to the user or other parameters.

The invention improves the targeting accuracy and hence efficiency of retail advertising, (such as food advertising) by use of all of the above methods (interactive, behavioral, and contextual advertising) Improvement in the relevance of an ad to the recipient thereof is paramount to the system; relevance here is taken to involve many factors, and includes but is not limited to the following meanings of the term:
a. Relevance of advertised item to customer
b. Relevance of customer to advertiser
c. Timing of advert
d. Context of advert
e. Context of customer
f. Advertising return on investment (ROI)
g. Usefulness to customer

The invention consists of the following components:
a. A shopping list application running on a mobile device, PC, internet, cloud computing, etc.
b. An advertising component in communication with the shopping list application.
c. A server adapted for storing user information, copies of shopping lists, and advertiser information, as well as comprising software adapted for implementation of the system.

Included as part of these components, various interfaces and reminders are used, such as:
a. Interfaces for retailers and other advertisers.
b. Interface for recipes
c. Interface for social networking
d. Location based purchase reminders
e. Schedule based purchase reminders

The shopping list application (henceforth, “the application”) enables users (typically households) to better manage their shopping activities. A first step of registration involves standard processes of identification, authorization, establishment of credit and the like. After registration, a user accesses his/her account through an interface that can run on the web, as well as through a dedicated smartphone or other appliance application running on a given mobile device (such as a smartphone, a tablet-pc, etc.). The application will include the following functions:
a. Creation, maintenance, sharing, and browsing of shopping lists.
b. Creation of field items for shopping lists including pictures, barcodes, names, quantities, brands, types, locations, times of availability, etc.
c. Creation of multiple shopping lists for different events or supermarkets.
d. Ability to save a shopping list for future use
e. Targeted distribution of advertisements (further details below).
f. Recommendation of items to add to the shopping list, based on previous consumption patterns, statistical correlations, and other information as analyzed using various algorithms.
g. Scanning of cash register slips using OCR techniques, and providing users statistical data about their consumption and expenditures (see further details below).
h. Ability to add products to list, either by typing, speech to text technology, receipt of shared items, or the like.
i. Ability to share information regarding products with other accounts (social networking —for example, a user will be able to post from within the application a message like “In shop X the fruit today are of very good quality” to his friends in the social network).
j. Functions to organize the list in an optimal order to minimize the time spending in the shop. Organizing can be manual, alphabetic, chronological, categorical, or based on recommendation given by the system. Such recommendations may rely for instance on previous in-shop behavior of the user and/or on mathematical analysis of other users' behavior who visited the same shop in the past.
k. Provision to define items in a list as emergency items, which need to be bought ASAP. The application will generate a reminder which may be location or time based (or combinations of these); for instance a reminder may be issued as soon as the shopper approaches close enough to a shop that sells these items, or when a certain time defined by the user is reached.

### Distribution of Advertisements

The application enables advertisers to send targeted ads directly into users shopping lists. These ads may be triggered for instance by keywords appearing in the shopping list. For example consider the following scheme which embodies one aspect of the invention:

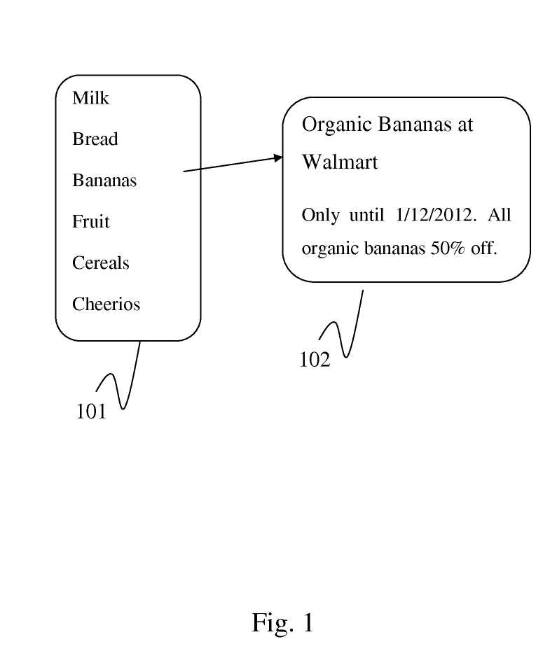

An advertiser will define a list of keywords, the appearance of which in the shopping list will trigger the appearance of his add. For example: milk, bread, bananas, fruit, cereals, cheerios, may be selected as keywords by a given advertiser (See FIG. 1).

Here the triggering keywords 101 are used to trigger a corresponding ad 102. Each keyword may trigger a given specific advertisement.

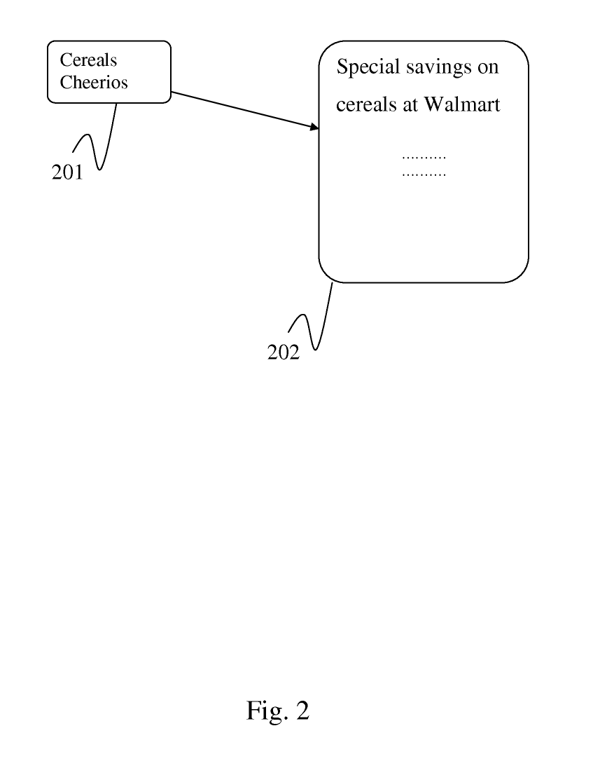

For such purposes, advertisers create an ad, which may include advertising text, a discount coupon, or any other relevant content, that might persuade the user to shop in the advertiser's store (see FIG. 2). From all the shops of an advertiser, he will select those for which this ad will be shown (henceforth, “participating shops”). Further conditions for the triggering of an advertisement are provided as well, including keywords or groups of related keywords that trigger an ad; time-based criteria; demographic criteria concerning the shopper; demographic and geographic criteria concerning the shop; and the like. Combinations of these criteria can be specified in order to define a very specific niche to which the ad is targeted. It is within provision of the invention to define an advertiser's ‘relevance score’ which comprises (for example) a weighted sum of functions of these individual criteria.

It is within provision of the invention that an icon indicating that there is a relevant advertisement for this product appears next to a given item in a shopping list. This advertisement may be for example placed by a shop located close to a location where the shopper in question has shopped recently, or close to the place he is currently located, or close to any other significant location for the user (such as his home or workplace).

The server and/or client application of the system will select among all users who have shopping lists with the keywords selected by the advertiser, the most relevant users for the ad to be presented to, according to criteria including location, history, timing, projected needs, and the like, and combinations thereof. For example ads may be served by particular advertisers to:
Users that have shopped in the past X months in locations a within a radius of Y kilometers (or a travel time of Z minutes) from a given set of shops.
Users whose home or work address (or the route between the two) is located in a radius of Y km from one of the participating shops.
Users who are currently located in the radius of Y from one of the participating shops.

The ad(s) are presented to users passing these filters within the shopping list in the following manner:

In the shopping list itself, ads in one embodiment are presented as icons (henceforth, “teasing icons”), next to the entries of given list items. These may be for instance items that are or are related to one of the keywords selected by the advertiser. The appearance of such a keyword item on a user's list can trigger an ad from a given advertiser, if the user meets various criteria as described above (such as past history, location, time and the like).

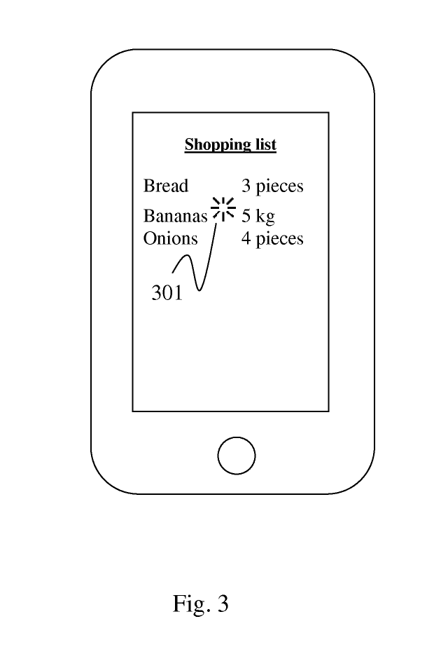

Clicking on such a teasing icon will open an ad, with the contents determined by the advertiser (see FIG. 3).

It is within provision of the invention to use icons indicating that there is a relevant advertisement for this product fulfilling various criteria, some of which may be user-selectable, some of which may be advertiser-selectable, and some of which may be selectable by both parties or a third party such as the system operator. These ads may be for example related to a shop located close to the place the user shopped recently, or to the place he is currently located, or close to any other significant location for the user (such as his home or workplace).

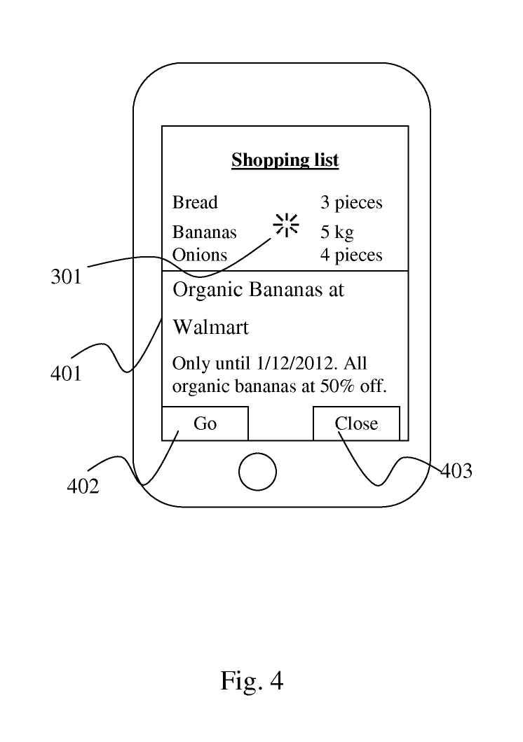

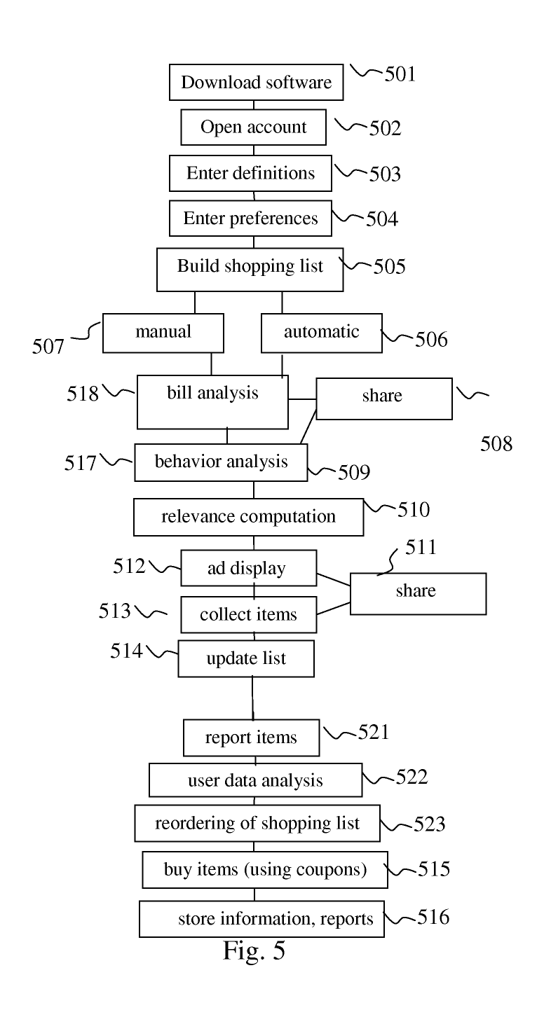

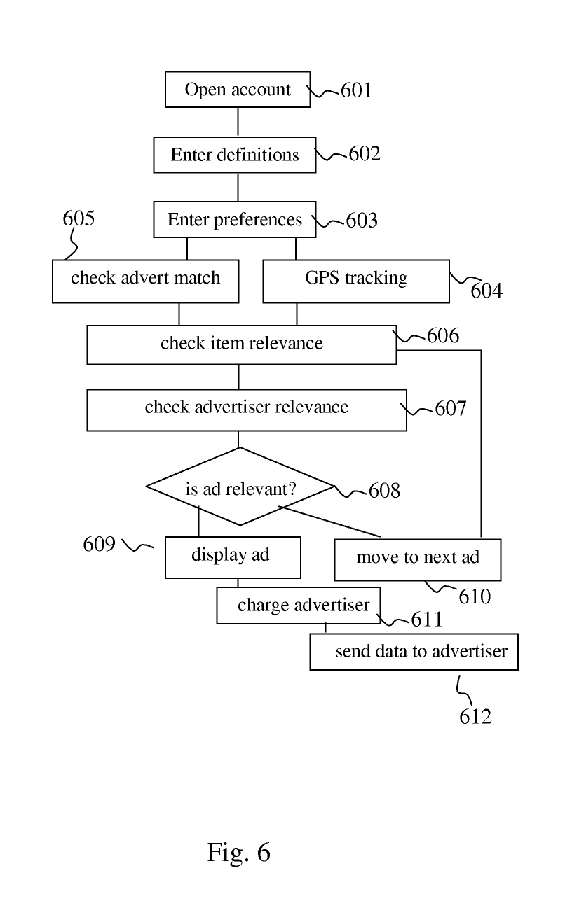

For example, FIG. 4 illustrates an ad 401 that appears when a user clicks on a teasing icon 301. The ad 401 may be provided with buttons 402, 403 for interaction, for example allowing the user to dismiss the ad 403 or use it 402 as a coupon.

The teasing icons can be ad-specific, (for example, incorporating small image of the advertised product), or advertiser-specific (for example, incorporating the advertiser logo), so that the user gets a general idea what the advertisement is about before clicking the teasing icon.

It is within provision of the invention that there be more than one teasing icon per each product entry in the shopping list (for example, different advertisers that use the same keyword).

In some embodiments of the invention, the shopper is given provision to opt out from seeing a specific ad, or from receiving ads from a specific store, or from receiving ads in a specific geographical region. More generally, a user can define positive criteria (such as requesting to be shown ads only from specific retailers, or only from a specific area, and so on), or negative criteria (such as requesting the blocking of a particular ad, or ads from certain shop, or group of shops, or geographic location, and so on).

As mentioned above, an ad can comprise a discount coupon. These coupons can have barcodes or QR-codes that can be read at the cash register scanner, directly from the display of the mobile-device. This method simplifies the usage of these coupons by the shoppers, to a large extent.

In addition, there will be a possibility of showing advertisements in the form of banners or voice ads, in other selected locations in the application, such as the opening screen.

In some embodiments of the invention a software application is provided allowing users to scan their cash register slips into the application, either by the camera built into the mobile-device, or by any other scanner. The application, with the help of OCR techniques, will build a database with the data from the slips. The database with the data from the OCR can be used , in addition to the various statistical reports mentioned, to assist in the process of building new shopping lists, for example by recommending items to be bought, and where to buy them.

Afterwards, users will be able to get various statistical reports from this database about their expenditures. These reports may comprise for example:
Total expenditure over time.
Expenditure on specific product or product group over time.
Distribution of the total expenditure between various product groups.
Correlations between purchases
Frequency analyses of purchases

Those skilled in the art will appreciate that such a tool can provide the household with insights needed to better manage expenditures. Furthermore based on such analyses (such as the frequency analysis, which as will be clear to one skilled in the art may be implemented by means of a Fourier or similar transform) a ‘likelihood of necessity’ may be defined. Thus for example a user who reliably purchases a quart of milk each week will have a high likelihood to continue doing so, which likelihood will be detected by the system and used for purposes of advertising and/or suggesting the item if it appears to have been forgotten from a particular week's shopping list.

Furthermore correlations between different items may be determined, both for a given user and on average, as well as between different users. Thus for example if on average users who buy diapers also buy baby formula, this will result in a high correlation between these items. Therefore the system may usefully suggest baby formula to those seen to be buying diapers, and/or advertisement related to baby formula may be presented to users buying diapers. As will be appreciated by one skilled in the art binary correlations of this sort may be collected in a matrix Aᵢⱼ, while more complex correlations between (for instance) any number of items may be determined by the tensor A_{ijk . . . z}. These tensors or matrices may be determined as stated either for a given user and/or on average for all users; less obviously, correlations between pairs or groups of users can also in this way be determined Thus if for instance it is determined that when user N buys items K, it is highly likely that user M buys item L, this correlation may be used to predict M's purchase of L before the fact, contingent on user N's purchase of item K. This information may likewise be compiled in appropriate tensors, whose elements may be scanned for entries of high correlation.

Interface for retailers

The interface for retailers comprises the following components and functions:
Ability to define the shops that belong to the advertiser. For each shop, the exact geographical location of the shop will be determined (for example by online means or by manual entry e.g. in terms of longitude and latitude). A helper tool may in some cases be provided for easily deriving location data by pinpointing shops location on a map.
Ability to define advertising campaigns. A campaign consists of an ad, a group of keywords that trigger this ad (both these were described in detail earlier), and the following parameters:
   Start and end dates of the campaign.
   Shops that participate in the campaign (from all the shops of the advertiser).
Ability to provide the advertiser with statistical reports about the performance of his campaigns.

### Interface for Advertisers

Advertisers (including those that are not retailers) will be able to place their ads in areas in the application that will be predefined, some of which may be outside the shopping list (such as on opening and closing screens). The interface for use by these advertisers provides inter alia the ability to:
Upload advertising content (such as banners).
Select where in the application the advertisement will appear.
Define start and end dates for the advertising campaign
Define the geographical area where the ad will be presented
Create statistical reports about the performance of his campaigns.
Define demographical characteristics of the target audience of the campaign.

Payment for advertising may in some embodiments of the invention be based on a model of fixed costs (for example, per shop, per campaign, etc.), to which may be added variable costs (for example, per click, or per view). Pricing of each component may be individually determined, depending on such factors as expected exposure and competition.

It is within provision of the invention to define a relevance of a given ad to a given user. This may be for instance accomplished by means of ‘yes/no’ filters, ultimately resulting in a binary value for relevance or lack thereof of a given ad to a given user. Thus for instance an ad-user pair passing all filters (of age, residence, job location, store location, etc) will be judged to be relevant and the ad will be presented to the user. Alternatively, the relevance may be determined as (for instance) a percentage; thus as a user's residence is closer and closer to the ‘desired location’ of interest to an advertiser, a location score will rise; similarly, scores for all other indices are defined, and the final relevance may be determined by means of the product of all such scores. Mathematically both approaches may be written as

$$R = {\prod }_{k = 1}^{N} {r}_{k}$$

where R is the computed relevance and the rₖ are individual scores of relevance on individual indices. Thus for example if the target demographic is 30-40 years old, and the user is 29 years old, the relevance may be (for instance) judged to be 90%. If the binary approach is taken then the relevance is 0 for anyone outside the desired age range. Similarly if the store is located within a certain threshold of the user's daily commute, the relevance for this index will be high, dropping with distance by use of some function of distance. If the binary approach is taken then the relevance drops to 0 when the location in question is outside a given threshold radius of the drivers daily commute.

### Flowcharts

To better illustrate the operation of the invention we make use of the flowcharts in FIGS. 5,6.

In FIG. 5, the flowchart for a user's operation of the user portion of the system is shown. Software associated with the system will allow for the user to download the software 501, either to a PC, to a smartphone, or the like. Once this has been accomplished the user opens an account 502, and enters definitions 503 including but not limited to user details, permissions (such as whether to use GPS data or not), payment details, and the like. Then a step of defining preferences 504 is carried out, including preferred location(s), hour(s), food preferences (such as dietary restrictions/favorites/limitations), distance to store, travel time to store, and the like. Thereupon a step of building the shopping list 505 is performed. This may done manually 507, automatically 506, or some combination of the two. For instance, an ‘autocomplete’ feature may be used to automatically complete entries based on their initial letters as entered by the user. Fully automatic entries may be suggested by the system as well, based on previous purchases; for instance if every week a quart of milk is bought, the system may use various algorithms including but not limited to artificially intelligent algorithms to predict the timing of the next purchase, and use these predictions to make automatic entries to the list. The user may enter products or shopping list items using keyboard, speech, or the like for entry. The system may recommend items to buy based on previous consumption patterns, as gleaned for instance from previous shopping lists, previous purchases, data from a database, OCR of receipts, and the like. It is within provision of the invention that the list be adjusted based on various factors such as the current number of people in a household. Once the list has been constructed it may be shared with other system users by various communications means, in effect implementing a social network.

As mentioned above the system may analyze previous purchases in an attempt to predict future purchases. For this purpose the system may be fed information such as previous bills for analysis 517; this information may be entered manually or by means of OCR, speech to text or any other means appropriate as will occur to one skilled in the art. The behavior of the user is also subject to analysis 509; this includes not only the items purchased, but also the conditions and context; the locations at which items are purchased; the time of day; the time of week; the time of month and year; correlations with sales; and in principle all possibly relevant information including but not limited to weather, economic indicators, interest rates, political situations, and the like. Once the full shopping list has been built or at any stage along the way, the list, analysis 518, and behavior analysis 517 may be shared 508 either with other users, advertisers, or system operators.

Once the various analyses have been performed a relevance computation 510 is performed. This calculation determined the relevance of a given ad to a given user at a given time, and is accomplished as described above by means of either applying a series of binary filters or otherwise computing a relevance score (which may constitute for example a product of individual relevance indices) and thresholding this score.

If a particular ad is determined to be relevant (or relevant enough) the ad is displayed 512. The customer meanwhile collects items 513, possibly checking them off the list which is then updated 514. All these operations may be shared in parallel 511 with other users of the system. The items may now be reported 521, and user analysis performed 522. Based on items collected, the shopping list may now be reordered 523, for instance by alphabetic arrangement of remaining items, or by geometric layout of remaining items based on store floorplan, or the like. The user may ask the system for a suggested item-collection order. The system can generate such a suggestion based on this user's behavior in previous purchases, or on mathematical analysis of all users that shopped in this shop till now, or other analysis.

Once all of the items on the list have been collected, the user buys items 515 possibly using coupons that may be offered in conjunction or as part of the ads displayed by the system. For example, the ads may comprise scannable barcodes that the teller of a store may read using standard barcode reader technology. After purchases have been made, associated information is stored and reported 516, for instance sending the list of items purchased and the context in which they are purchased to various factors such as the system operator, advertiser, user, other users, and the like. It is within provision of the invention that the user goes to the cash register and buys the items whenever he decides to (not necessarily after he collected all the items in the list).

A flowchart of the advertiser process is now studied in FIG. 6. Here the advertiser opens an account 601, enters definitions 602 and preferences 603 (such as preferred user demographic, desired keywords, and other contextual information intended to match advertisements to particular users or user segments). Advertisements are checked 605 and sent to various user accounts based on the match between desired and actual parameters. GPS tracking 604 may be used in conjunction with the system to allow the system awareness of the user's location. Item relevance is furthermore checked 606 in terms of user and advertiser preferences 607. If the ad is judged relevant 608, the ad is displayed 609, while if not the system moves on to the next ad 610 in cyclical fashion. If the ad is in fact displayed 609 the advertiser is charged 611 using appropriate means, and the relevant data sent to advertiser 612.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A method for targeted advertising comprising steps of:
a. composing a shopping list;
b. compiling advertising information;
c. compiling user information;
d. determining the relevance of a given advertisement to a given user;
e. presenting advertisements to selected users depending upon said relevance.

2. The method of claim 1 further determining the relevance of a given advertisement to a given user, in a given shopping list, in a given product entry.

3. The method of claim 1 further presenting advertisements to selected users in the context of the selected shopping list, in the context of the selected product entry, depending upon said relevance.

4. The method of claim 1 wherein said advertising information comprises: keyword; distance between user domicile and a given outlet; minimum distance between user commute route and a given outlet; distance between user work location and a given outlet; distance from historic purchase locations of the user; distance for user's location when activating the application.

5. The method of claim 2 wherein said distances are selected from the group consisting of: Euclidean distance; travel time; and functions thereof.

6. The method of claim 1 wherein said user information comprises: user age;
user gender; user domicile location; user income; user family status; user work location; user commute route.

7. The method of claim 1 wherein said relevance is determined by means of a set of filters based on said advertising information, said user information, relevance of item to customer, relevance of customer to advertiser, timing of advert, context of advert, context of customer, advertising return on investment (ROI), and advertisement usefulness to customer.

8. The method of claim 7 wherein said relevance R is computed by means of the product
$$R = {\prod }_{k = 1}^{N} {r}_{k}$$
where R is the computed relevance and the rk are individual scores of relevance on individual indices.

9. The method of claim 8 wherein said advertisement is presented to said user if said relevance R is greater than a predetermined threshold.

10. The method of claim 1 further comprising means for storing historical shopping list information.

11. The method of claim 10 further comprising means for prediction of shopping needs based on said historical information.

12. The method of claim 1 wherein said shopping list is composed by means selected from the group consisting of: manual input; automated prediction; and combinations thereof.

13. The method of claim 1 implemented on a mobile device.

14. The method of claim 1 wherein said advertising information and said user information are stored on means selected from the group consisting of: a server associated with said method; a mobile device associated with said user; and combinations thereof.

15. A system for targeted advertising comprising:
a. a shopping list;
b. advertising information;
c. user information;
d. means for determining the relevance of a given advertisement to a given user;
e. means for presenting advertisements to selected users depending upon said relevance.

16. The system of claim 15 wherein said advertising information comprises: keyword; distance between user domicile and a given outlet; minimum distance between user commute route and a given outlet; distance between user work location and a given outlet distance from historic purchase locations of the user; distance for user's location when activating the application.

17. The system of claim 16 wherein said distances are selected from the group consisting of: Euclidean distance; travel time; and functions thereof.

18. The system of claim 15 wherein said user information comprises: user age;
user gender; user domicile location; user income; user family status; user work location; user commute route.

19. The system of claim 15 wherein said relevance is determined by means of a set of filters based on said advertising information, said user information relevance of item to customer, relevance of customer to advertiser, timing of advert, context of advert, context of customer, advertising return on investment (ROI), and advertisement usefulness to customer.

20. The system of claim 19 wherein said relevance R is computed by means of the product
$$R = {\prod }_{k = 1}^{N} {r}_{k}$$
where R is the computed relevance and the rₖ are individual scores of relevance on individual indices.

21. The system of claim 20 wherein said advertisement is presented to said user if said relevance R is greater than a predetermined threshold.

22. The system of claim 15 further comprising means for storing historical shopping list information.

23. The system of claim 22 further comprising means for prediction of shopping needs based on said historical information.

24. The system of claim 15 wherein said shopping list is composed by means selected from the group consisting of: manual input; automated prediction; and combinations thereof.

25. The system of claim 15 implemented on a mobile device.

26. The system of claim 15 wherein said advertising information and said user information are stored on means selected from the group consisting of: a server associated with said method; a mobile device associated with said user; and combinations thereof.
